(19) United States
(12) Patent Application Publication
(10) Pub. No.: US 2009/0231309 A1
(43) Pub. Date: Sep. 17, 2009

(54) Plasma Display Panel and Plasma Display Device

(76) Inventors: Akira Otsuka, Kunitomi (JP); Takashi Sasaki, Kunitomi (JP); Akihiro Takagi, Kunitomi (JP)

Correspondence Address: MCDERMOTT WILL & EMERY LLP, 600 13TH STREET, N.W., WASHINGTON, DC, 20005-3096, US

(21) Appl. No.: 12/083,778

(22) PCT Filed: Dec. 2, 2005
(86) PCT No.: PCT/JP2005/022211

§ 371 Date: Oct. 15, 2008

(51) Int. Cl. G06F 3/038; H01J 17/49

(52) U.S. Cl. 345/204; 313/586; 345/60

(57) ABSTRACT

In a long-gap discharge using a trigger discharge in a display cell of a PDP having three electrodes (X, Y, A), a technology capable of stably generating the trigger discharge with low power consumption by using a float electrode is provided. In a dielectric layer of the PDP, a long gap is formed between first and second display electrodes, first and second float electrodes which are capacitive-coupled to the first and second display electrodes are formed, and a short gap is formed between the first and second float electrodes. A sustain pulse is applied to the first and second display electrodes, thereby generating a small trigger discharge in the short gap. Subsequently to this discharge, a main discharge at the long gap is generated. Electrodes and capacitances are structured so that the main discharge has an intensity equal to or smaller than one-fifth of an intensity of the trigger discharge.

### TECHNICAL FIELD

The present invention relates to a technology of a plasma display panel (PDP) and a plasma display device (PDP device) and more particularly, the present invention relates to display driving and a configuration of electrodes and others of a PDP.

### BACKGROUND ART

Conventionally, as a method of improving emission efficiency of a PDP, a long-gap discharge using a trigger discharge in a display cell has been known. For example, there is a four-electrode PDP device in which a PDP having a first (X) electrode and a second (Y) electrode on a first substrate (front substrate) side and a third (A) electrode as an address electrode on a second substrate (back substrate) side is further provided, and a Z (fourth) electrode is further provided between the X and Y electrodes, so that a trigger discharge is generated between the Z electrode and the X or Y electrode.

Also, Japanese Patent Application Laid-Open Publication No. H11-238462 (Patent Document 1) discloses an example in which float-shaped electrodes (island-shaped conductors) are provided onto a substrate as an electrode structure of a display cell.

Patent Document 1: Japanese Patent Application Laid-Open Publication No. H11-238462 (FIG. 3 and FIG. 4)

### DISCLOSURE OF THE INVENTION

In the conventional PDP technologies, high emission efficiency can be achieved in the long-gap discharge in a display cell, but a firing voltage is high. In a method of driving the above-mentioned four-electrode PDP device, in order to decrease the firing voltage, a trigger discharge is used where a voltage is applied to the Z electrode between the display electrodes and the voltage is made to be 0 immediately after firing.

However, in the conventional configuration, it has been difficult to perform control of stopping the pulse only by the trigger discharge, and further, power consumption is increased due to capacity load of the display cells, and thus it resulted in a decrease in efficiency. In other words, it has been difficult to stably generate a small trigger discharge with low power consumption.

In the technology disclosed in Japanese Patent Application Laid-Open Publication No. H11-238462 (Patent Document 1), a discharge equivalent to a trigger discharge is generated by the float-shaped electrodes, and it has a structure where a discharge gap between the float-shaped electrodes is identical to that of a gap between display electrodes (main-discharge gap). In this structure, a sustain voltage of the main discharge is not so decreased, thereby only achieving a small improvement in emission efficiency.

The present invention has been made in view of the above-described problems, and an object of the present invention is to provide a structure capable of generating a stable trigger discharge with low power consumption and providing excellent emission efficiency by a PDP using float electrodes in a PDP-device technology.

The typical ones of the inventions disclosed in this application will be briefly described as follows. To achieve the above object, the present invention is a technology for an AC-type color PDP device comprising a PDP and a driving circuit of the PDP, which performs display using the subfield method by causing a sustain discharge (repeated discharge) between X and Y electrodes of each display cell of the PDP, and float electrodes are provided to the PDP, and the following structure is featured. That is, the PDP is configured by a plurality of display cells arranged in a matrix in a first (lateral) direction and a second (longitudinal) direction, and their vertical direction is taken as a third direction.

In the technology according to the present invention, mainly in the PDP configuration, a pair of float electrodes capacitive-coupled to a pair of electrodes for main discharge is formed near a main-discharge gap and is used for trigger discharge. A PDP configuration is provided where the main-discharge gap (first gap) and a trigger-discharge gap (second gap) are independently designed and the intensity of the trigger discharge can be arbitrarily designed, depending on the shape, arrangement, and others of the float electrodes. In particular, in a dielectric layer (insulating layer), a float-electrode surface is arranged so as to partially overlap a display-electrode surface forming the first gap and protrudes above the first gap when viewed on a display surface.

In the PDP device of the present invention, in each display cell of the PDP, first and second float electrodes capacitive-coupled to first and second electrodes (particularly, transparent first and second electrodes) as a pair of electrodes for main discharge are provided, and a voltage pulse is applied between the first and second electrodes from a driving circuit, thereby generating a subtle trigger discharge between the first and second float electrodes. Then, subsequently to the trigger discharge, a main discharge is developed between the first and second display electrodes. Due to the capacitive coupling between the display electrode and the float electrode, an electric field is decreased by wall charge caused by the discharge (trigger discharge), and thus the discharge automatically ending with a short discharge. Once the trigger discharge is generated, a long-gap discharge is generated between the display electrodes, thereby improving emission efficiency.

(1) The PDP of the present invention is a PDP having a first (X) electrode, a second (Y) electrode, and a third (Z) electrode in, for example, a dielectric layer, and having the following configuration in each display cell configured by including the first, second, and third electrodes. The first and second electrodes, particularly, the PDP's display electrodes extend in a first direction and have their edges facing each other in a second direction, thereby forming a first gap (long gap) for a first discharge. Correspondingly to the first and second electrodes, two island-shaped electrodes, i.e., a fourth electrode (hereinafter referred to as a first (X) float electrode) and a fifth electrode (hereinafter referred to as a second (Y) electrode) are provided.

In the dielectric layer, the first and second float electrodes are provided in an area near the first gap and the display electrodes and are slightly away from each other in a third direction. The first float electrode and the second float electrode face each other, thereby forming a second gap (short gap). Further, the first and second float electrodes have, when viewed on a display surface, a surface area (second area) partially overlapping the first and second electrodes (display electrodes), and a surface area (first area) not overlapping these electrodes. In the second area, the first and second float electrodes are capacitive-coupled to the first and second electrodes (display electrodes) with a capacitance (Cf). A distance between edges (Lz) of the second gap between the first and second float electrodes is smaller than a distance between edges (Lg) of the first gap between the first and second electrodes (display electrodes) (Lz<Lg). That is, the float electrode protrudes above the first gap having the surface area (first area) not overlapping the display electrode surface.

A discharge sustain voltage pulse (sustain pulse) or its conforming voltage pulse is applied between the first and second electrodes (display electrodes) from a driving circuit side to the PDP during a sustain period, so that a first discharge (trigger discharge) is generated between the float electrodes (in the second gap). Then, as the first discharge terminates, a second discharge (main discharge) with higher intensity is generated between the first and second electrodes (in the first gap). In this manner, light emission is caused at a target display cell. The sustain pulse mentioned above is a pulse by a sustain voltage Vs including a repetition of positive and negative pulses having opposite poles at X and Y.

And, in the above-described PDP, depending on the shape, arrangement, and the material of the dielectric layer and electrode groups, the intensity of the first discharge is equal to or smaller than one-fifth of the intensity of the second discharge, or the total current of the first discharge is equal to or smaller than one-fifth of the total current of the second discharge.

(2) Further, in a PDP similar to the PDP in the item (1) above, the above definition of the intensity or total current of the discharge is as follows. The PDP of the present invention has the coupled capacitance (Cf) between the first and second electrodes (display electrodes) and the float electrode equal to or smaller than one-fifth of a discharge-insulating-layer capacitance (Cdm) of the first and second electrodes (display electrodes) where the second discharge is generated.

(3) In the PDP of the item (1) or (2) described above, in the display cell, the area of the first and second float electrodes is smaller than the area of the first and second electrodes (display electrodes) including a portion to be capacitive-coupled on the display surface.

However, as to the design of the electrode areas described above, it is effective as it is when, for example, the shape of the electrode surface is a relatively simple rectangle, and these areas are designed in consideration of, for example, the first area, the second area, and a connecting portion (a third area) between the first area and the second area of the float electrode in the case where the shape is complex.

(4) In the PDPs of the items (1) to (3) described above, a width (Wf) in the first direction of the first and second float electrodes in the display cell varies according to positions in the second direction, and the width is small near the edges of the first gap between the first and second electrodes.

In other words, the first and second float electrodes each has a shape including the first area on the first gap, the second area on the display electrode, and the third area as a connecting portion between the first area and the second area including a portion being small near the edge of the first gap.

(5) In the PDPs of the items (1) to (3) described above, the first float electrode and the second float electrode in the display cell, the width (Wf) in the first direction varies according to positions in the second direction, and the edge of the first gap between the first and second electrodes (display electrodes) has no portion overlapping the first and second float electrodes on the display surface (i.e., is not covered).

In other words, each electrode has a shape with the first area on the first gap, the second area on the display electrode, and the third area positioned not through the edges of the first gap.

Further, for example, as with the first gap, the edges of the second gap between the float electrodes are shaped to extend in the first direction (facing each other in the second direction). Moreover, for example, the edges of the second gap may be shaped to extend in the second direction on the first gap (facing each other in the first direction).

(6) The followings are features in other configurations. The PDP of the present invention is configured by combining a first substrate side and a second substrate side interposing a discharge space and a barrier rib. The first substrate has a plurality of pairs of a first (X) electrode and a second (Y) electrode extending in substantially parallel in a first direction, which serve as electrodes for a sustain discharge, and first and second electrode groups are covered by a dielectric layer (insulating layer). The second substrate has a plurality of third (A) electrodes extending in substantially parallel in a second direction, which serves as an address electrode. The first substrate and the second substrate are separated from each other by, for example, a barrier rib extending in the second direction so that phosphor layers of respective colors are provided, and a display cell is configured by the first, second, and third electrodes.

Each display cell including an area where the first electrode and the second electrode are facing each other has the following configuration. The first and second electrodes are configured by having: linear first and second bus electrodes made of metal connected to a driving circuit side; and transparent first and second display electrodes electrically connected to the first and second bus electrodes. The above display electrode has a surface area protruding inward of the display cell from the above bus electrode. A first gap (=main-discharge gap=relatively long gap) is formed between the first display electrode and the second display electrode. Furthermore, a first float electrode capacitive-coupled to the first display electrode, and a second float electrode capacitive-coupled to the second display electrode are provided. A second gap (=trigger-discharge gap=relatively short gap) shorter than the first gap is formed between the first float electrode and the second float electrode above the first gap.

A voltage (sustain pulse) is applied between the first electrode and the second electrode from the driving circuit side, thereby generating a first discharge (trigger discharge) in the second gap, and subsequently, a second discharge (main discharge) is generated in the first gap. As a discharge mechanism, the first discharge terminates due to a decrease in electric field by the accumulation of wall charges in a discharge space, and the second discharge occurs.

And, the shape, arrangement, material, and others of respective electrode are determined correspondingly to the capacitive coupling described above, so that the intensity of the first discharge is equal to or smaller than one-fifth of the intensity of the second discharge.

(7) The PDP device of the present invention includes any one of the PDPs of the items (1) to (6) described above and respective driving circuits that apply a voltage to the first, second, and third electrodes of these PDPs. A voltage is applied from the driving circuit side to the first and second electrodes of the PDP, so that a trigger discharge is automatically generated between float electrodes, and then it is shifted to a main discharge between display electrodes.

The effects obtained by typical aspects of the present invention will be briefly described below. According to the present invention, in a PDP technology, a structure of a PDP using a float-shaped electrode in which a stable trigger discharge is generated with low power consumption and excellent emission efficiency can be provided.

### BRIEF DESCRIPTIONS OF THE DRAWINGS

FIG. 1 is a diagram showing an entire configuration of a PDP device according to an embodiment of the present invention;

FIG. 2 is a diagram showing a structure of each pixel unit of a PDP in the PDP device according to the embodiment of the present invention;

FIG. 3 is a plan view showing an electrode structure of a display cell in a PDP device according to a first embodiment of the present invention;

FIG. 4 is a cross-sectional view showing a structure of the display cell in the PDP device according to the first embodiment of the present invention;

FIG. 5 is a diagram showing respective capacitances of the display cell in the PDP device according to the first embodiment of the present invention;

FIG. 6 is a plan view showing an electrode structure of a display cell in a PDP device according to a second embodiment of the present invention;

FIG. 7 is a plan view showing an electrode structure of a display cell in a PDP device according to a third embodiment of the present invention; and

FIG. 8 is a plan view showing an electrode structure of a display cell in a PDP device according to a fourth embodiment of the present invention.

### BEST MODE FOR CARRYING OUT THE INVENTION

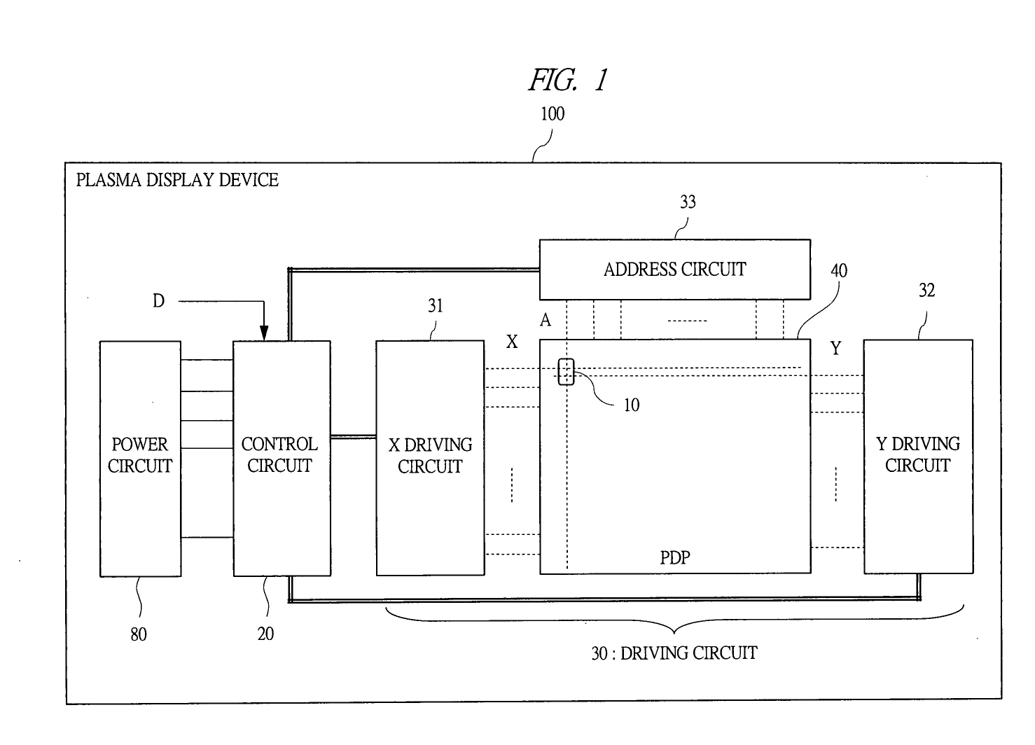

Hereinafter, embodiments of the present invention will be described in detail with reference to the accompanying drawings. Note that components having the same function are denoted by the same reference symbols throughout the drawings for describing the embodiment, and the repetitive description thereof will be omitted. FIG. 1 to FIG. 8 show the embodiments of the present invention.

An overview of the present embodiments is such that, as to X and Y electrodes of a display cell, in addition to bus electrodes and display electrodes, float electrodes for trigger discharge are provided, a trigger-discharge gap (Lz) between the float electrodes is formed to be smaller than a main-discharge gap (Lg) between the display electrodes, and a thickness (W2) of an insulating layer associated with trigger discharge is designed to be thinner than a thickness (W1) of an insulating layer associated with a main discharge. In this manner, in sustain driving of the display cell, a discharge (trigger discharge) is started (fired) by a voltage lower than that of the main discharge, and is then shifted to the main discharge. Also, it is configured such that a capacitance (Cf) between a float electrode and a display electrode is equal to or smaller than at least one-fifth of a main-discharge film capacitance (Cdm) so that the intensity of the trigger discharges is lower than the intensity of the main discharge.

### First Embodiment

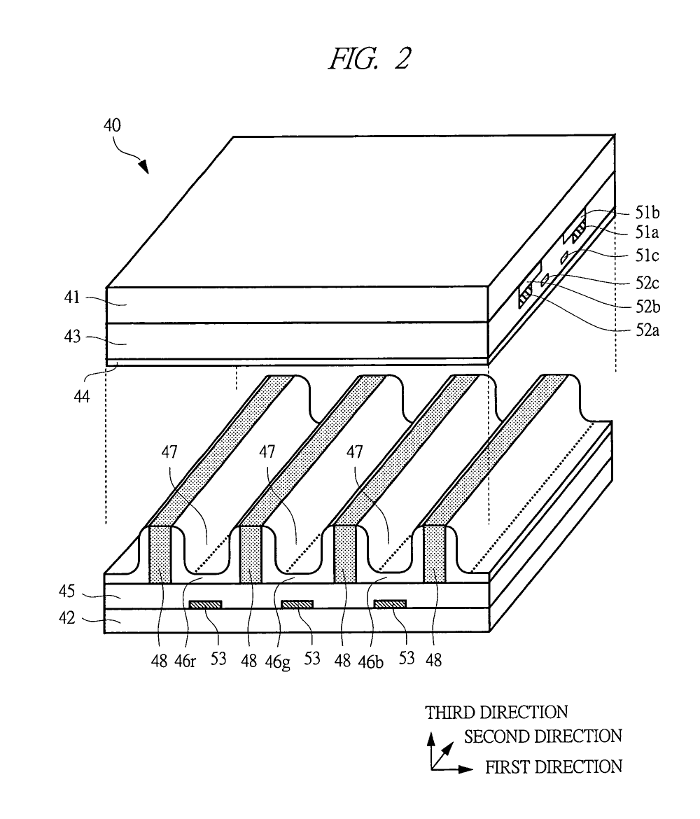

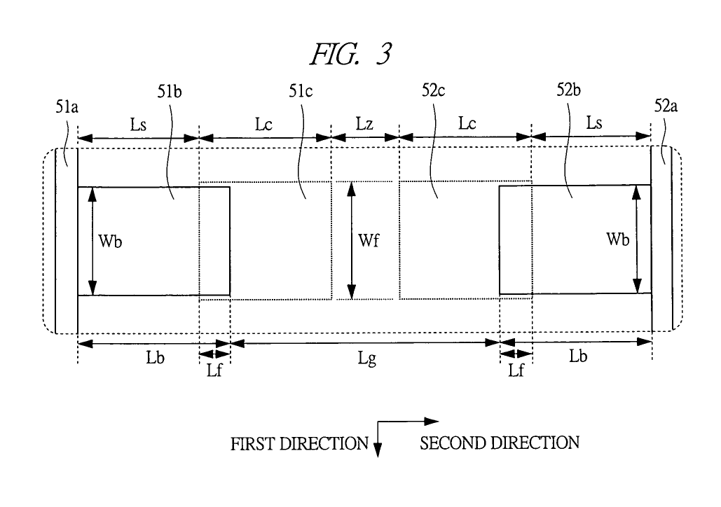

FIG. 1 to FIG. 2 show basic configurations of a PDP device 100 according to a first embodiment. FIG. 1 shows an entire configuration of the PDP device 100 including a driving circuit 30 for a PDP 40. FIG. 2 shows a configuration example of the PDP 40 for each pixel unit. FIG. 3 to FIG. 5 show configurations of a unit of a display cell 10 in the PDP device 100 according to the first embodiment.

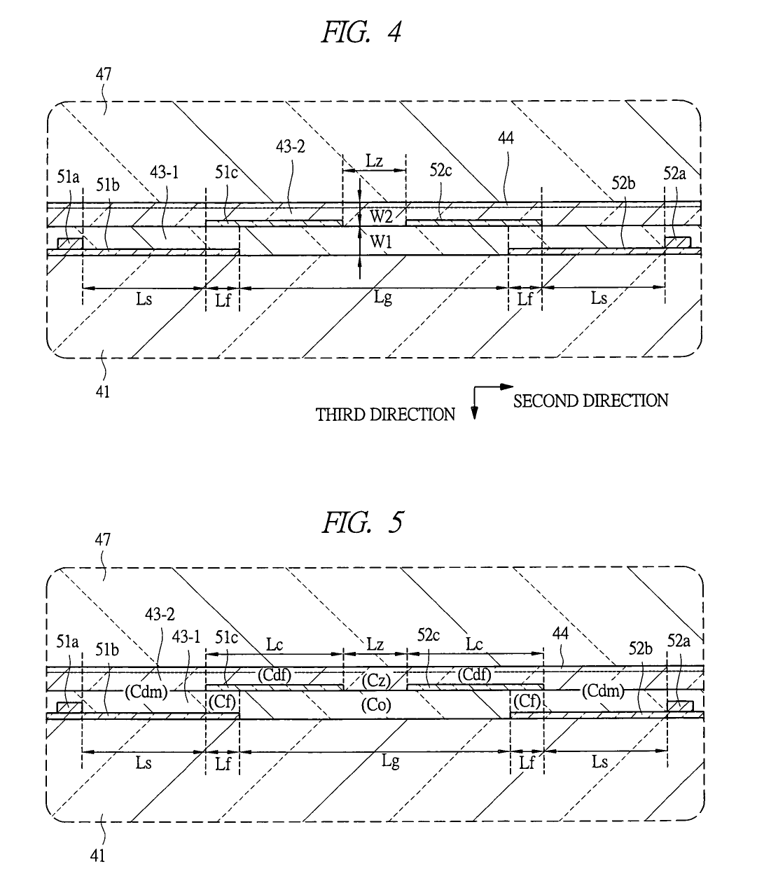

In the first embodiment, a structure of electrodes and others in each display cell of the PDP 40 is designed as shown in FIG. 3 and FIG. 4. In particular, the design of float electrodes (51c, 52c) for display electrodes (51b, 52b) in a dielectric layer 43 is a feature herein.

First, a basic configuration of the PDP device 100 according to the first embodiment is described. In FIG. 1, the PDP device 100 is configured to include, for example, the PDP 40 as a display panel unit, a driving circuit 30, a control circuit 20, and a power circuit 80. The driving circuit 30 is connected to the PDP 40, and the control circuit 20 is connected to the driving circuit 30. Here, the control circuit 20 and other components may be included to be referred to as the driving circuit 30. The power circuit 80 supplies voltages required for driving and control, such as a sustain voltage Vs and an address voltage Va, to the control circuit 20 and other components.

The hardware configuration of the PDP device 100 is such that, for example, a back surface of the PDP 40 is attached onto a chassis unit not shown, and a back surface side of the chassis unit has a PDP module on which an IC having respective circuit units such as the control circuit 20 mounted thereto, a power circuit unit, and others are arranged. A circuit unit on the back surface side of the chassis unit and an end of an electrode of the PDP 40 are connected by a driver module corresponding to the driving circuit 30. The PDP module configured as above is accommodated in an outer chassis, thereby configuring a PDP device set.

The control circuit 20 forms a control signal for controlling the driving circuit 30 based on a display signal (D), an interface signal, and other signals inputted thereto, thereby controlling the driving circuit 30. The control circuit 20 includes, for example, a display-data control unit that controls supply of display data to the driving circuit 30, and a timing control unit that generates a timing signal for controlling timing of display process and supplies the timing signal to the driving circuit 30. The control circuit 20 performs signal processing on the display signal (D), generates display data to be supplied to the PDP 40, stores the display data in a memory of the display-data control unit, and controls an address circuit 33 and others based on the display data.

The driving circuit 30 has an X driving circuit 31, a Y driving circuit 32, and an address circuit 33. The driving circuit 30 drives an electrode group of the PDP 40 according to a control signal from the control circuit 20. The X driving circuit 31 drives an X electrode of the PDP 40. The Y driving circuit 32 drives a Y electrode of the PDP 40. The Y driving circuit 32 includes a scan driving circuit (scan driver), thereby driving the Y electrode as a scan electrode. The address circuit 33 drives an address (A) electrode of the PDP 40 based on a signal of the display data. In the PDP 40, a display cell 10 is formed by respective areas where the A, X, Y, electrodes are crossing one another.

In FIG. 2, the PDP 40 is configured by substrates mainly formed of two glass plates, that is, a front substrate 41 and a back substrate 42. The PDP 40 is configured by attaching the front substrate 41 and the back substrate 42 so that they face each other interposing barrier ribs 48 and others, and a space therebetween (a discharge space 47) is exhausted and filled with a discharge gas and then sealed.

On the front substrate 41, a plurality of sets of a first (X) electrode and a second (Y) electrode are provided in a first direction in substantially parallel to each other. The X and Y electrode serve as sustain electrodes for sustain discharge. And, the Y electrode also serves as a scan electrode. The X and Y electrodes on the front substrate 41 are covered by a dielectric layer (also referred to as an insulating layer) 43 and a protective layer 44.

Further, on the back substrate 42, a plurality of address electrodes 53 as third (A) electrodes are arranged in substantially parallel to each other in a second direction orthogonal to the first direction in which the X and Y electrodes extend. Each address electrode 53 has a substantially linear shape made of metal, and is covered by a dielectric layer 45.

Between the front substrate 41 and the back substrate 42, the plurality of barrier ribs 48 are formed in order to form an area divided in the form of stripes in the second direction, for example. In an area divided by the barrier ribs 48, each display cell 10 is formed including areas where the respective electrodes are crossing each other. In the areas divided by the barrier ribs 48, phosphor layers {46r, 46g, 46b} of respective colors of R (red), G (green), and B (blue) are separately applied on the dielectric layer 45 and side surfaces of respective barrier ribs 48. By a set of these display cells 10 of R, G, and B, a pixel is formed. The display cell 10 has a shape that is longer in the second direction, and a set of the display cells 10 of R, G, B, form a pixel having a nearly square shape. Here, the display cell 10 can be a box type where the barrier ribs are provided also in the first direction.

On the front substrate 41, the respective X and Y electrodes are configured having a bus electrode and a display electrode (also referred to as a discharge electrode or a transparent electrode) in the present embodiment, and also having a float electrode. The bus electrode is an electrode made of metal in a linear bar-shape electrically connected to the driving circuit 30 side. The display electrode is a transparent electrode formed of an ITO (indium tin oxide) layer film and the like to form a main-discharge gap. The float electrode is a transparent electrode independently present in the dielectric layer 43. Note that, the float electrode can be made of metal. Float electrodes corresponding to the X and Y electrodes will be respectively referred to as an X float electrode 51c and a Y float electrode 52c, hereinafter.

In the present embodiment, an X display electrode 51b and a Y display electrode 52b are formed in a third direction on the front substrate 41, and on these display electrodes, an X bus electrode 51a and a Y bus electrode 52a are formed. Further above, slightly away from these bus electrodes, the X float electrode 51c and the Y float electrode 52c are formed. A set of the X bus electrode 51a, the X display electrode 51b, and the X float electrode 51c forms the X electrode. The same goes for the Y electrode. The dielectric layer 43 comprises two layers in the present embodiment, that is, a first dielectric layer 43-1 and a second dielectric layer 43-2, corresponding to the formation of the float electrodes. The dielectric layer 43 and the dielectric layer 45 are formed of SiO₂, for example. The protective layer 44 is formed of MgO, for example.

As a method of driving the PDP 40 in the PDP device 100, a subfield method is used. One field (e.g., 16.7 ms) corresponding to one display screen of the PDP 40 includes a plurality of time-divided subfields (SF) of SF1 to SFn (e.g., n is 10). Each SF has a rest period (Tr), an address period (Ta), and a sustain period (Ts), in this order. Each SF is weighted based on the difference in the sustain period (Ts), that is, the number of times of sustain discharge. According to combination patterns of On/Off of these SFs, gray-scale display is performed at each display cell.

In the display driving of the PDP 40, first, as a reset operation in the reset period (Tr), remaining charges are uniformed. Next, as an address operation in the address period (Ta), a discharge is made between A-Y electrodes by driving (applying an address pulse and a scan pulse) from the address circuit 33 and the Y driving circuit 32. Consequently, data memory is performed at the display cell 10 to be On. Then, as a sustain operation in the sustain period (Ts), a sustain discharge (repetitive discharge) is made between X-Y electrodes by driving (applying a sustain pulse) from the X driving circuit 31 and the Y driving circuit 32, thereby generating a discharge light emission at the display cell 10 to be On.

Next, features of the present embodiment will be described. In the present PDP device 100, based on the conventional PDP technology for three electrodes (X, Y, A), surface discharge (X-Y discharge), and color (R, G, B) compliant, as shown in FIG. 3 and FIG. 4, the structure on the front substrate 41 side, which is a display surface side of the PDP 40, is fabricated.

FIG. 3 shows an electrode structure of a planar region corresponding to the display cell when viewed from a display plane side of the PDP 40, that is, the third direction. In this region, for example, the barrier ribs 48 and the address electrodes 53 are omitted. FIG. 4 shows a layer structure of a partial area corresponding to the display cell 10 as viewing a cross section of the PDP 40 in the third direction. For example, the front substrate 41, the back substrate 42, and the discharge space 47 are omitted because the length of these components in the third direction is long compared with, for example, the dielectric layer 43.

In the present PDP 40, as shown in FIG. 3, in each display cell 10, the float electrodes (51c, 52c) are provided at positions where they partially overlap the display electrodes (51b, 52b). A gap (Lz) between the float electrodes (51c, 52c) is shorter than a gap (Lg) between the display electrodes (51b, 52b). Further, as shown in FIG. 4, the float electrodes (51c, 52c) are provided in the dielectric layer 43 at the front substrate 41 side.

In fabrication of the PDP 40, on the front substrate 41 (on the back surface side), the X and Y display electrodes (51b, 52b) forming the long gap (Lg) as a first gap, and the X and Y bus electrodes (51a, 52a) are formed. On these electrodes, the transparent first dielectric layer 43-1 (permittivity (∈)=4, film thickness (W1)=4 μm) is formed, and then the transparent island-shaped X and Y float electrodes (51c, 52c) are formed. The X and Y float electrodes (51c, 52c) overlap the corresponding X and Y display electrodes (51b, 52b) by a width Lf in the first direction, thereby forming a second gap (Lz) between the X and Y float electrodes (51c, 52c). The second gap (Lz) is shorter than the first gap (Lg). Thereafter, a second dielectric layer 43-2 and the protective layer 44 of, for example, about 0.7 μm are vapor-deposited on the entire surface, and are then combined with the back substrate 42 side on which the address electrodes 53, the barrier ribs 48, the phosphor layers {46r, 46g, 46b}, etc. are formed. Then, for example, sealing, exhausting, and filling of discharge gas are performed on the combined substrates and the discharge space 47, thereby completing the PDP 40.

Upon turning-on the display cell 10, in the sustain period (Ts) after reset and address operations in the SF, a discharge sustain voltage pulse (sustain pulse) is applied from the driving circuit 30 side to the target X and Y electrodes of the PDP 40, that is, the X and Y bus electrodes (51a, 52a). The sustain pulse is formed of a repetition of positive and negative pulses mainly with the sustain voltage Vs. In this manner, in the display cell 10 to be On, a small first discharge (trigger discharge) is first generated between the float electrodes (51c, 52c), and then a second discharge (main discharge) is generated between the display electrodes (51b, 52b).

In FIG. 3 and FIG. 4, Wf represents a width of the float electrodes (51c, 52c) in the first direction, and Wb represents a width of the display electrodes (51b, 52b) in the first direction. Lg represents a gap between the display electrodes, which is a distance between edges of the display electrodes (51b, 52b) facing each other in the second direction. Lz represents a gap between the float electrodes, which is a distance between edges of the float electrodes (51c, 52c) facing each other in the second direction. Lf represents an overlapping width between the display electrode (51b, 52b) and the float electrode (51c, 52c) in the second direction. Ls is a display discharge width, which is a length obtained by a length (Lb) of the display electrode (51b, 52b) protruding in the second direction from the bus electrode (51a, 52a) where the width (Lf) overlapping the float electrode (51c, 52c) is extracted. Lb represents the length of the display electrode (51b, 52b) in the second direction (the length of the protruding portion from the bus electrode). Lc represents a length of the float electrode (51c, 52c) in the second direction. W1 represents a thickness of the first dielectric layer 43-1 (first insulating layer), whilst W2 represents a thickness of a layer (second insulating layer) obtained by combining the second dielectric layer 43-2 and the protective layer 44.

Since there are overlapping surfaces, 0<Lf<Lb, Lc. Also, in the present embodiment, Wf>Wb (or W Wb) and Lc<Lb. Also, in the insulating layers associated with discharge capacitance, W1>W2. In the display cell 10, when viewed from the display surface, for X, Y each, the area (Lc×Wf) of the float electrode (51c, 52c) is made smaller than the area (Lb×Wb) of the display electrode (51b, 52b). Also, the overlapping area (Lf×Wb) of the float electrode (51c, 52c) with the display electrode (51b, 52b) is made smaller than the non-overlapping area. The thickness of the display electrode (51b, 52b) and the thickness of the float electrode (51c, 52c) are substantially equal to each other, and are smaller than the thickness (W1, W2) of the insulating layer.

Capacitances associated with determinations of discharge characteristics in the display cell 10 are defined as follows. FIG. 5 is a diagram for describing each capacitance corresponding to the definition. Permittivity is represented bye. Hereinafter, the second dielectric layer 43-2 and the protective layer 44 are considered as one insulating layer (second insulating layer) and, in particular, calculation is conducted assuming that the second insulating layer is formed only of MgO.

Co: Co represents a capacitance between the X-Y electrodes, that is, a capacitance when it is assumed that no float electrode is present but only the front substrate 41 and the dielectric layer 43. Co is mainly determined based on the configuration of the X and Y electrode areas, the first gap (Lg), ∈ of the front substrate 41, and the dielectric layer 43 (the first and second insulating layers).

Cf: Cf represents a trigger discharge capacitance, that is, a capacitance by capacitor coupling between the display electrode and the float electrode, and is proportional to the overlapping area (≈Lf×Wb) between the display electrode and the float electrode and ∈ of the first insulating layer, and inversely proportional to the thickness (W1) of the first insulating layer.

Cz: Cz represents a capacitance between float electrodes, that is, a capacitance between the float electrodes (51c, 52c) when it is assumed that no X and Y display electrodes (51b, 52b) are provided.

Cdm: Cdm represents a main-discharge-film capacitance (discharge-insulating-layer capacitance), that is, a capacitance (film capacitance of discharge surface) of a portion (main discharge surface) of the display electrodes (51b, 52b) not covered with the float electrodes (51c, 52c) in the display surface. Cdm is proportional to its main discharge surface area (Ls×Wb) and ∈ of the dielectric layer 43 (first and second insulating layers), and is inversely proportional to the thickness (W1+W2) of these insulating layers.

Cdf: Cdf represents a capacitance of float electrode film, and is proportional to the area (Lc×Wf) of the float electrodes (51c, 52c) and ∈ of the second insulating layer, and is inversely proportional to the thickness (W2) of the second insulating layer.

Also, an applied voltage between the X-Y electrodes is taken as a sustain voltage Vs. Also, a voltage between the float electrodes (51c, 52c) (a voltage at which a discharge starts between the float electrodes) is taken as a voltage between float electrodes Vz.

In the foregoing, when Cf >>Cz (Cf is sufficiently larger than Cz), the voltage between float electrodes Vz can be represented by the following Equation (1). In this manner, a voltage that is substantially Vs is applied to the second gap (Lz) between the float electrodes (51c, 52c).

Vz=Vs×Cf/(Cf+2Cz)≈Vs (1)

According to the application of the voltage (Vs) between the X-Y electrodes, when a discharge is generated in the second gap between the float electrodes (51c, 52c), due to capacitance division by Cf and Cdf, the potential of the float electrodes (51c, 52c) will be abruptly decreased, then the discharge between the float electrodes (51c, 52c) will be stopped. When this discharge between the float electrodes (51c, 52c) forms a space charge (such as ions in the discharge space 47), the firing voltage between the X-Y electrodes is decreased, thereby causing a large discharge. For this reason, the first discharge between the float electrodes (51c, 52c) is called a trigger discharge, whilst the subsequent second discharge between the X-Y electrodes is called a main discharge.

By the trigger discharge, the long gap discharge in the first gap (Lg) between the display electrodes (51b, 52b) is generated as the main discharge at a voltage lower than that of the trigger discharge. Therefore, in the display cell 10, the discharge has a low space charge density, thereby improving emission efficiency of ultraviolet ray, in other words, the efficiency of emission of visible light from the phosphor layers 46 is improved.

To improve emission efficiency, the intensity of the trigger discharge is required to be smaller than that of the main discharge, and is desirable to be at least equal to or smaller than one-fifth of the intensity of the main discharges. In the present embodiment, it is designed to satisfy the above-described conditions regarding the shape and arrangement of the display electrodes (51b, 52b) and the float electrodes (51c, 52c) of the PDP 40, and so forth.

To make the intensity of the trigger discharge smaller than the intensity of the main discharge, the capacitance (=trigger-discharge capacitance Cf) between the float electrode (51c, 52c) and the display electrode (51b, 52b) in each of X and Y is decreased with respect to the insulating-film capacitance (=main-discharge-film capacitance Cdm) of the main discharge. When the main-discharge-film capacitance Cdm is equal or larger than fivefold the trigger-discharge capacitance Cf (Cdm>5×Cf), the potential on the X and Y float electrodes (51c, 52c) as trigger electrodes becomes equal to the potential on the X and Y display electrodes (51b, 52b) by a wall charge amount of trigger discharge that is one-fifth of a wall charge amount by the main discharge. That is, the intensity of the trigger discharge can be reduced to about one-fifth of the intensity of the main discharge.

In the PDP device 100, the float electrodes (51c, 52c) partially overlaps the display electrodes (51b, 52b) in the dielectric layer 43 in the display surface, and the float electrodes (51c and 52c) have their edges protruding inwards above the main discharge gap (Lg), thereby forming the short gap (Lz) between the float electrodes (51c, 52c). Also, regarding each of the capacitances (including Cdm and Cf) associated with the display electrodes (51b, 52b) and the float electrodes (51c, 52c), the configuration is made such that the abovementioned condition to be smaller than one-fifth is satisfied.

In the present embodiment, when the thickness (W1) of the first dielectric layer 43-1 is 4 μm/∈=4, and the second insulating layer is made of only MgO and has the thickness (W2) of 0.7 μm/∈=10, and further, Lz=50, Lg=100, Lx=120, and Lf=20 (the unit is μm, respectively), a ratio of the main-discharge-film capacitance Cdm to the trigger-discharge capacitance Cf (Cdm:Cf) is represented by the following Equation (2).

Cdm:Cf≈(120×4/4):(20×4/4)=6:1 (2)

That is, when the intensity of the trigger discharge is one-sixth of the intensity of the main discharge, their surface potentials are substantially equal to each other, thereby stopping (terminating) the discharges.

In the present embodiment, ∈ of the first dielectric layer 43-1 is low and the thickness (W1) thereof is thin. Even so, the sustain voltage of the long-gap discharge (discharge in Lg) in the case without a trigger discharge (in the case of the conventional PDP) is as high as 200 V or higher, and so it results in a high discharge-peak current and a decrease in emission efficiency. On the other hand, in the case with a trigger discharge by the float electrodes (51c, 52c) (in the case of the present PDP 40), the sustain discharge is generated at about 180 V in the long gap (Lg), and then the total discharge current and intensity are decreased compared with the case of the conventional technology, thereby increasing emission efficiency by about 10%.

Also, a ratio of the main-discharge-film capacitance Cdm to the float-electrode-film capacitance Cdf (Cdm:Cdf) is represented by the following Equation (3).

Cdm:Cdf=(120×4/4):(45×10/0.7)≈1:5 (3)

That is, the float-electrode-film capacitance Cdf is substantially five-times larger than the main-discharge-film capacitance Cdm, but the total discharge current is substantially one sixth. Therefore, even when the second insulating layer is made of MgO only, sputtering of MgO (ion bombardments in the discharge space 47) due to discharge concentration can be mitigated.

In the above calculation, it is assumed that the second insulating layer is made of MgO only. Alternatively, in the area of the second insulating layer in the area of the dielectric layer 43, it is possible to use a configuration where a plurality of layers that are different in property from each other is provided, for example, a configuration of a combined film of a thin film such as glass and MgO, or a configuration where no protective layer 44 is provided, and conversely, a configuration where only the protective layer 44 is provided.

According to the configuration of the first embodiment, particularly, the float electrodes (51c, 52c) as trigger electrodes are capacitive-coupled to the display electrodes (51b, 52b) via Cf, and a special voltage pulse for generating a trigger voltage (trigger pulse for the Z electrode in the conventional four-electrode PDP device) is not used. According to the present embodiment, the intensity of the main discharge and the intensity of the trigger discharge can be independently designed, and a weak trigger discharge can be generated at a low voltage and the short gap (Lz). Further, a main discharge is generated at a low voltage and the long gap (Lg). Therefore, emission efficiency of the display cell 10 is high. Since display with high emission efficiency can be achieved by the present PDP device 100, brightness/contrast of display can be improved, and power consumption can be reduced.

### Second Embodiment

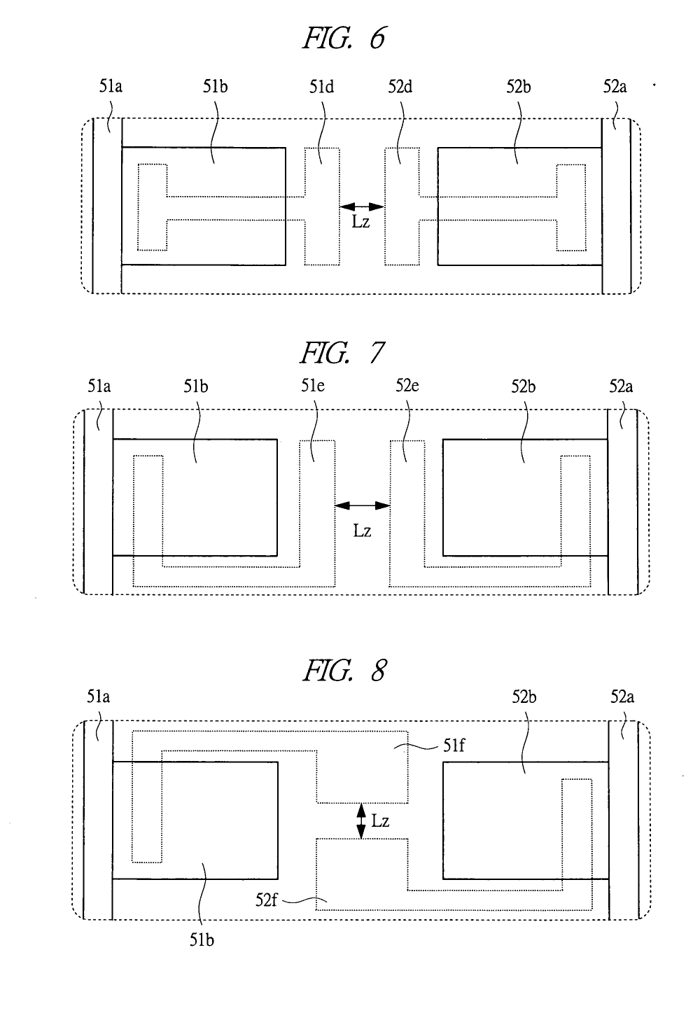

In a second embodiment, in a basic configuration similar to that in the first embodiment, an electrode structure at the front substrate 41 side of the PDP 40 is fabricated as shown in FIG. 6. Float electrodes (51d, 52d) are in a shape having less area overlapping the edges of the display electrodes (51b, 52b) facing each other. That is, each of the float electrodes (51d and 52d) has a surface portion (first area) forming a gap (Lz) for trigger discharge and not overlapping the display electrode (51b, 52b) surface, a surface portion (second area) overlapping the display electrode (51b, 52b) for capacitive coupling, and a portion (third area) connecting the first and second areas and provided through the facing edge (edge of the main-discharge gap (Lg)) of the display electrode (51b, 52b).

In the second embodiment, since the third area is reduced, fluctuations in the capacitance Cf depending on the alignment accuracy of patterning of the display electrodes (51b, 52b) and the float electrodes (51d, 52d) in the PDP 40 can be reduced, thereby facilitating device fabrication. In other words, in the second embodiment, even if patterning alignment has a slight misalignment, the area size of the first area mainly contributing to trigger discharge at the float electrodes (51d, 52d) does not change substantially. In this manner, the above-described effects and discharge stability are expectable.

### Third Embodiment

In a third embodiment, in a basic configuration similar to that of the first embodiment, an electrode structure at the front substrate 41 side of the PDP 40 is fabricated as shown in FIG. 7. Float electrodes (51e, 52e) have a shape without area that overlaps edges of the display electrodes (51b, 52b) facing each other. In other words, each of the float electrodes (51e, 52e) has a surface portion (first area) that forms the gap (Lz) for trigger discharge and does not overlap the display electrode (51b, 52b) surface, a surface portion (second area) that overlaps the display electrode (51b, 52b) surface for capacitive coupling, and a portion (third area) connecting the first and second areas and not going through the facing edge of the display electrode (51b, 52b) but going through an area (a vicinity area in the first direction) by the display electrode (51b, 52b) so as to extend in the second direction.

The third embodiment, similarly to the second embodiment, further tolerates a misalignment in patterning alignment between the display electrode (51b, 52b) and the float electrode (51e, 52e). And also, as to the display surface, the float electrode (51e, 52e) does not overlap in the vicinity of the edge of the main-discharge gap (Lg) (there is no overlapping area), thereby achieving a stable discharge at a low voltage.

### Fourth Embodiment

In a fourth embodiment, in a basic configuration similar to that in the first embodiment, an electrode structure at the front substrate 41 side of the PDP 40 is fabricated as shown in FIG. 8. Float electrodes (51f, 52f) have a shape where the area overlapping the edges of the display electrodes (51b, 52b) facing each other is eliminated, and the edges forming a trigger gap (Lz) are extending in the second direction and facing each other in the first direction. In other words, each of the float electrodes (51f, 52f) has a main surface portion (first area) forming the gap (Lz) for trigger discharge and not overlapping the display electrode (51b, 52b) surface, a surface portion (second area) overlapping the display electrode (51b, 52b) surface for capacitive coupling, and a portion (third area) connecting the first and second areas and not going through the facing edges of the display electrode (51b, 52b) but going through an area by the display electrode (51b, 52b). In this manner, effects similar to those in the third embodiment and others can be achieved.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention is applicable to a display device, such as a PDP device.

1. A plasma display panel having a first electrode and a second electrode extending in a first direction in a dielectric layer,
wherein, in each display cell are configured including the first and second electrodes,
the first and second electrodes have their edges extending in the first direction and facing each other in a second direction to form a first gap, and
a first float electrode and a second float electrode are included in the dielectric layer correspondingly to the first and second electrodes,
wherein the first float electrode is separated from the first electrode and partially overlaps the first electrode in a display surface, thereby having a capacitance with respect to the first electrode, and the second float electrode is separated from the second electrode and partially overlaps the second electrode in the display surface, thereby having a capacitance with respect to the second electrode,
wherein the first float electrode and the second float electrode have their edges facing each other in the second direction and extending above the first gap, thereby forming a second gap smaller than the first gap,
wherein a voltage pulse is applied between the first and second electrodes, so that a first discharge is generated in the second gap, and subsequently a second discharge is generated in the first gap, and
wherein an intensity of the first discharge is equal to or smaller than one-fifth of an intensity of the second discharge, or a total current of the first discharge is equal to or smaller than one-fifth of a total current of the second discharge.

2. A plasma display panel having a first electrode and a second electrode extending in a first direction in a dielectric layer,
wherein, in each display cell are configured including the first and second electrodes,
the first and second electrodes have their edges extending in the first direction and facing each other in a second direction to form a first gap, and
a first float electrode and a second float electrode are included in the dielectric layer correspondingly to the first and second electrodes,
wherein the first float electrode is separated from the first electrode and partially overlaps the first electrode in a display surface, thereby having a capacitance with respect to the first electrode, and the second float electrode is separated from the second electrode and partially overlaps the second electrode in the display surface, thereby having a capacitance with respect to the second electrode,
wherein the first float electrode and the second float electrode have their edges facing each other in the second direction and extending above the first gap, thereby forming a second gap smaller than the first gap,
wherein a voltage pulse is applied between the first and second electrode, so that a first discharge is generated in the second gap, and subsequently a second discharge is generated in the first gap, and
wherein a capacitance between the first float electrode and the first electrode and a capacitance between the second float electrode and the second electrode are equal to or smaller than one-fifth of a capacitance of a discharge-insulating layer of the first and second electrodes where the second discharge is generated.

3. The plasma display panel according to claim 2,
wherein, in the display cell, an area of the first float electrode is smaller than an area of the first electrode in the display surface, and an area of the second float electrode is smaller than an area of the second electrode.

4. The plasma display panel according to claim 2,
wherein, in the display cell, the first float electrode and the second float electrode each have a width in the first direction which varies depending on a position in the second direction, and the width is small near an edge of the first gap in the display surface.

5. The plasma display panel according to claim 2,
wherein, in the display cell, the first and second float electrodes each have a width in the first direction which varies depending on a position in the second direction in the display surface, and have no portion which overlaps an edge of the first gap.

6. The plasma display panel according to claim 2,
wherein, in the display cell, the first and second float electrodes each have a width in the first direction which varies depending on a position in the second direction in the display surface, and have a shape where edges of the second gap extend in the second direction above the first gap and face each other in the first direction.

7. The plasma display panel according to claim 2,
wherein a dielectric layer is provided between the first and second electrodes and the first and second float electrodes, and
only a protective layer is provided on the first and second float electrodes.

8. A plasma display panel comprising a first substrate and a second substrate which are combined facing each other interposing a discharge space, the plasma display panel comprising:
a plurality of pairs of a first electrode and a second electrode extending in a first direction and covered with a dielectric layer on the first substrate; and
a plurality of third electrodes extending in a second direction and covered with a dielectric layer on the second substrate,
wherein, a space between the first substrate and the second substrate is divided by barrier ribs and phosphor layers of respective colors are provided, thereby forming display cells including the first, second, and third electrodes in the areas divided by the barrier ribs,
wherein, in each display cell including an area where the first electrode and the second electrode face each other,
the first electrode is configured to have a first bus electrode having a linear shape and a first transparent display electrode electrically connected to the first bus electrode and protruding inward of the display cell,
the second electrode is configured to have a second bus electrode having a linear shape and a second transparent display electrode electrically connected to the second bus electrode and protruding inward of the display cell,
a first gap is formed between the first display electrode and the second display electrode,
a first float electrode capacitive-coupled to the first display electrode and a second float electrode capacitive-coupled to the second display electrode are provided in the dielectric layer,
a second gap shorter than the first gap is formed between the first float electrode and the second float electrode,
a voltage is applied between the first electrode and the second electrode, thereby generating a trigger discharge in the second gap, and subsequently generating a main discharge in the first gap, and
an intensity of the trigger discharge is equal to or smaller than one-fifth of an intensity of the main discharge.

9. A plasma display device comprising:
a plasma display panel having a first and second electrodes extending in a first direction in a dielectric layer on a first substrate and a third electrode serving as an address electrode on a second substrate;
a first driving circuit that applies a voltage to the first electrode;
a second driving circuit that applies a voltage to the second electrode; and
a third driving circuit that applies a voltage to the third electrode,
wherein, in each display cell formed by including the first, second, and third electrodes,
the first electrode and the second electrode have their edges extending in the first direction and facing each other in a second direction, thereby forming a first gap,
a first float electrode and a second float electrode are provided in the dielectric layer correspondingly to the first and second electrodes,
the first float electrode is separated from the first electrode and partially overlaps the first electrode in a display surface, thereby being capacitive-coupled to the first electrode,
the second float electrode is separated from the second electrode and partially overlaps the second electrode in the display surface, thereby being capacitive-coupled to the second electrode,
the first float electrode and the second float electrode have their edges facing each other in the second direction, thereby forming a second gap smaller than the first gap,
a voltage pulse is applied between the first and second electrodes from the first and second driving circuits, thereby generating a first discharge in the second gap, and subsequently generating a second discharge in the first gap, and
an intensity of the first discharge is equal to or smaller than one-fifth of an intensity of the second discharge or a total current of the first discharge is equal to or smaller than one-fifth of a total current of the second discharge.
